(19) United States
(12) Patent Application Publication
(10) Pub. No.: US 2009/0319605 A1
(43) Pub. Date: Dec. 24, 2009

(54) MOTION STATE INDICATOR FOR LOCATION-BASED SERVICES

(75) Inventors: Lauri Aarne Johannes Wirola, Tampere (FI); Ismo Kullervo Halivaara, Tampere (FI); Jari Tapani Syrjarinne, Tampere (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/390,412

(22) Filed: Feb. 21, 2009

Related U.S. Application Data
(60) Provisional application No. 61/030,888, filed on Feb. 22, 2008.

(51) Int. Cl. G06F 15/16

(52) U.S. Cl. 709/203; 709/217

(57) ABSTRACT

A system and method by which an estimate can be provided to a location-based service provider concerning the motion state of a user of a terminal. Motion state information may be used to trigger a particular location-based service at a more desirable moment. The motion state information may also be used to help define the format of information sent to the user's terminal, as well as to define the content of the information that is to be sent to the user terminal. This enables an improved level of control of the distribution of location-based services, as information can be sent at a more optimal time and more relevant information can be sent to the user.

### RELATED APPLICATION

This application claims priority to U.S. application No. 61/030,888 filed Feb. 22, 2008, which is hereby incorporated by reference in its entirety.

### FIELD OF THE INVENTION

The present invention relates generally to location-based services. More particularly, the present invention relates to anticipatorily providing information and/or services to a user based upon the user's location.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Services based on the location of mobile devices are becoming increasingly widespread. In location-based services, content delivered and rendered at the device or terminal of a particular service requestor may change depending upon the location of the service requester. For example, in the case of advertisements, different advertisements may be sent to a terminal based upon the terminal's location.

Location-based services may also provide assistance data for assisted navigation systems, such as Global Navigation Satellite Systems (GNSS). Such assistance data has been specified and standardized for cellular systems, e.g., Assisted Global Positioning System (AGPS). A GNSS can comprise a network of satellites that broadcasts navigation signals including time and navigation data. GNSS receivers pick up these broadcasted navigation signals and calculate a precise global location based thereon. Examples of GNSS include, but are not limited to, global positioning systems (GPS), Galileo, GLONASS, satellite-based augmentation systems (SBAS), local area augmentation systems (LAAS) and quasi-zenith satellite systems (QZSS).

The delivery of such assistance data can be built on top of cellular system-specific control plane protocols including, e.g., the radio research location services protocol (RRLP) for GSM networks, the radio resource control (RRC) layer of layer 3 in wideband code division multiple access (WCDMA) networks, and IS-801 for CDMA networks.

One feature of location-based systems is the ability to anticipatorily send information of interest. For example, a person/terminal may be notified about a service and/or offer that is located within a certain number of meters of the terminal's location. The person then has the opportunity to “react” to the information. In a particular example, if a user is moving and comes within half a kilometer of a coffee shop, an advertisement for the coffee shop may be rendered on the user's terminal at the half-kilometer distance so that he or she has the opportunity to decide whether to stop at the coffee shop before passing it.

### SUMMARY OF THE INVENTION

Various embodiments provide a system and method by which an estimate can be provided to a location-based service provider concerning the motion state of a user of a terminal. Such motion state information may be used to trigger a particular location-based service at a more optimal moment. This motion state information may also be used to help define the format of information sent to the user's terminal, as well as to define the content of the information that is to be sent to the user's terminal. This enables an improved level of control of the distribution of location-based services, as information can be sent at a more optimal time and more relevant information can be sent to the user.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flow chart showing an exemplary implementation of various embodiments of the present invention;

FIG. 2 is a perspective view of an electronic device that can be used in conjunction with the implementation of various embodiments of the present invention;

FIG. 3 is a schematic representation of the circuitry which may be included in the electronic device of FIG. 2.

### DETAILED DESCRIPTION OF VARIOUS EMBODIMENTS

Various embodiments provide a system and method by which an estimate can be provided to a location-based service provider concerning that motion state of a user of a terminal. Such motion state information may be used to trigger a particular location-based service at an optimal moment. This motion state information may also be used to help define the format of information sent to the user's terminal, as well as to define the content of the information that is to be sent to the user's terminal. This enables an improved level of control of the distribution of location-based services, as information can be sent at a more optimal time and more relevant information can be sent to the user.

In a number of conventional systems for providing location-based services, the distance to a particular location is the only primary factor considered when deciding when a location-based service should be provided to a user terminal. For example, in the example of a coffee shop discussed previously, an advertisement for the coffee shop would be rendered on the user's terminal when the user terminal is within a half-kilometer distance of the coffee shop, regardless of the rate at which the user is travelling. Although this arrangement may be useful when the user is travelling at a low rate of speed, e.g., when the user is walking or jogging, it becomes significantly less useful when the user is travelling at highway speeds in an automobile, since the user would have only a few seconds to view the advertisement to decide whether or not to stop at the coffee shop and then change his or her driving course so as to stop at the coffee shop. However, by the time the user decides that he or she wants to stop, the vehicle may have already passed the coffee shop entirely.

In addition to the above, other content-related issues may not be addressed in a situation where the only information used in providing location-based services is the user's location at a given moment. For example, if the user terminal is being used by a pedestrian, the user may be able to simply enter a shop directly from the street in response to the viewing of a location-based advertisement. However, if the user is driving an automobile, the user may also have to find a parking space before entering the shop.

Various embodiments provide a system and method by which information about the motion state of the user terminal is used to provide location-based services. In various embodiments an estimate of the motion state of the user is provided to the location-based service provider, and this information is used to customize the content provided to the user and/or the timing at which the content is provided.

By providing motion state information, more relevant and better-timed location-based services can be provided to the user. Returning to the coffee shop situation, for example, the timing of the advertisement for the coffee shop can be adjusted based upon the motion state of the user. If it has been determined that the optimal time to provide the advertisement to the user is three minutes before the user would reach the coffee shop, then the motion state information could be used by the location-based service provider to deliver the advertisement when the user is a half-kilometer way, when the user is walking, or five kilometres away when the user is travelling in a car. Additionally, if the motion state information indicates that the user is travelling in a car, then the location-based service provider may decide to provide parking information to the user, in addition to the advertisement for the coffee shop. If, on the other hand, the motion state information indicates that the user is walking or jogging, then the parking information would not be sent since it is not needed by the user.

In various embodiments, information concerning the motion state of the terminal can be transmitted to the location-based service provider using, for example, a simple bit representation. A chart showing an example of how different motion states may be identified with bit representations is shown below.

| Motion state | Bits |
|---|---|
| Stationary | 0000 |
| Walking | 0001 |
| Running | 0010 |
| Cycling | 0011 |
| Skating | 0100 |
| Car | 0101 |
| Unknown motion | 1111 |

Information used to determine the motion state may be based upon, for example, a GNSS receiver velocity estimate and/or a sensor/sensor suite located within the user terminal. In the case where one or more sensors are used, the sensors may comprise, for example, inertial sensors. Although a GNSS receiver velocity estimate may pose issues in situations such as inner city driving, where a vehicle stuck in a traffic jam could be moving at a velocity similar to the rate at which a pedestrian or cyclist moves, for example, it does provide the benefit of including heading information which may also be of interest to an location-based service provider. If, for example, the user terminal is capable of indicating that the user is rapidly moving away from a coffee shop, then the location-based service provider would not provide an advertisement for that establishment. When a GNSS receiver velocity estimate is used, the motion state may be further defined relative to the estimated velocity of the terminal. For example, there could be multiple “Car” bit representations-one for highway speeds, one for city driving speeds, etc. In further embodiments, more accurate information concerning the velocity of the user terminal could be transmitted, making it possible for the location-based service provider to even further fine tune the content and/or timeliness of the location-based services.

In the case of an inertial sensor/inertial sensor suite, such components rely upon the idea that each transportation mode and motion state has its own vibration characteristics that can be used to differentiate between them. For example, the vibration characteristics for walking are different than for cycling, which are different for travelling in a vehicle, etc.

Regardless of whether sensors, a GNSS receiver velocity estimate, or other devices are used to determine the motion state, the categories of motion states can vary greatly. For example, individual motion states representing travel by automobile, train, boat, airplane, bicycle, etc. and other vehicles may be represented by different bit representations.

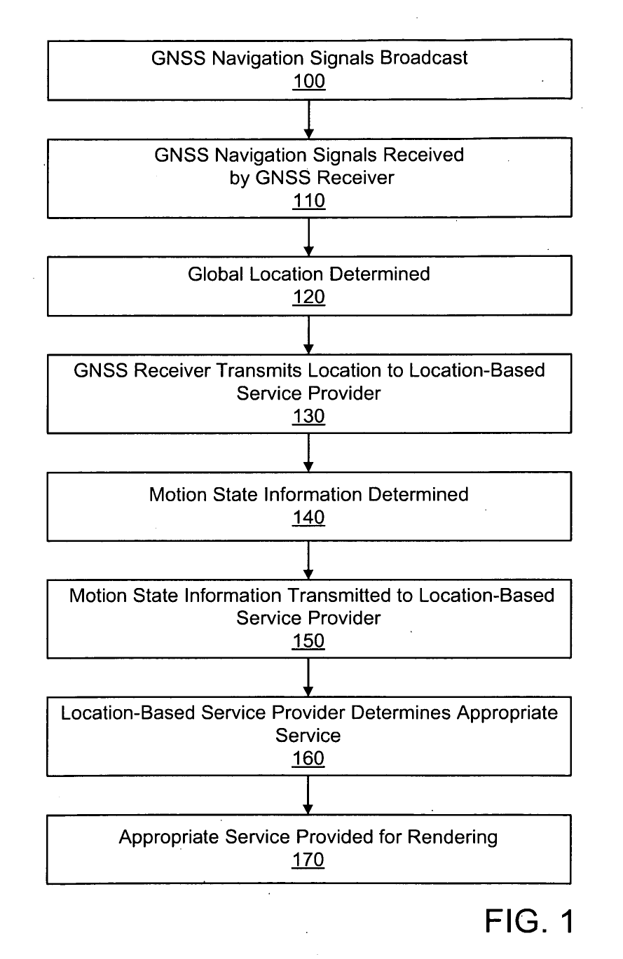

FIG. 1 is a flowchart showing an exemplary implementation of various embodiments of the present invention. At 100 in FIG. 1, a plurality of satellites in a GNSS broadcast navigation signals, which are received by a GNSS receiver/user terminal at 110. At 120, the GNSS receiver calculates a global location based upon the navigation signals. The global location may also be determined using other processes such as triangulation to cellular network base stations or Cell ID-based methods. At 130, the GNSS receiver transmits this location information to a location-based service provider. The precise type of network device may be part of a cellular or noncellular network. It should also be noted that the information transmitted concerning the GNSS receiver's location may comprise, for example, latitudinal and longitudinal coordinates, the identification of a cell within which the GNSS receiver is located for the serving cellular network and/or other information. Additionally, at 140, the GNSS receiver and/or other sensors also determine an estimated motion state, and information concerning this estimated motion state is also transmitted to the location-based service provider at 150. It should be noted that, although processes 140 and 150 are depicted as occurring after processes 120 and 130, one skilled in the art would understand that these processes can occur in the reverse order, or these processes can occur substantially in parallel with each other. At 160, the location-based service provider uses the information transmitted at 130 and 150 in order to determine an appropriate location-based service for the user terminal, and the network device transmits the selected location-based service to the user terminal at 170.

Various communication devices constructed according to different embodiments of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, IEEE 802.16, WiMax, etc. A communication device involved in implementing various embodiments of the present invention may communicate using various media including, but not limited to, radio, infrared, laser, cable connection, and the like.

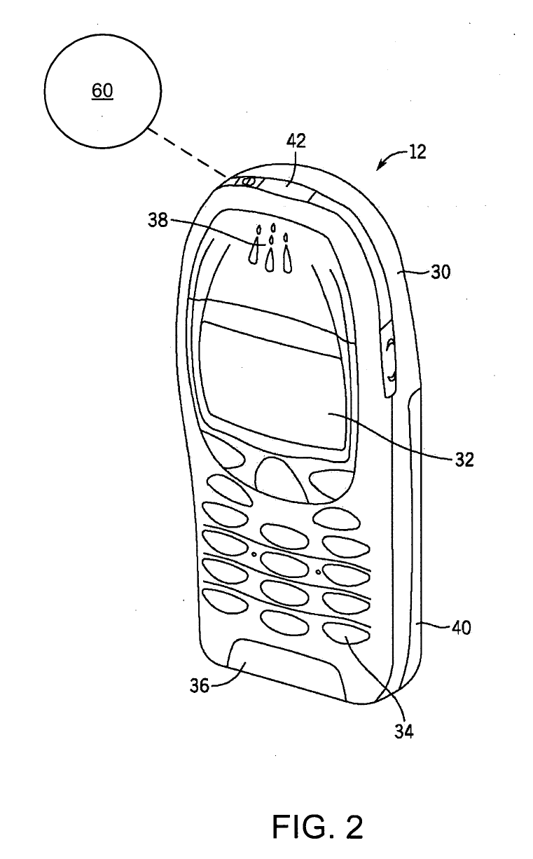

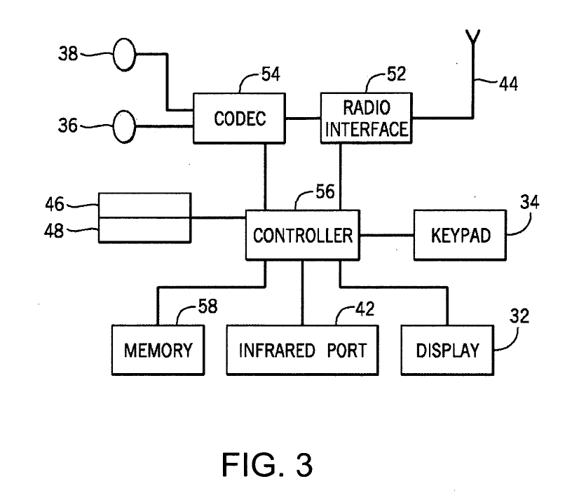

FIGS. 2 and 3 show one representative electronic device 12 within which the present invention may be implemented. It should be understood, however, that the present invention is not intended to be limited to one particular type of device. The electronic device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a Universal Integrated Circuit Card (UICC) according to one embodiment, a card reader 48, radio interface circuitry 52, codec circuitry 54, a controller 56 and a memory 58. Individual circuits and elements are all of a type well known in the art. FIG. 2 also graphically depicts a sensing unit 60 which may be used to measure environmental conditions in order to determine the motion state of the electronic device 12. As discussed above, the sensing unit may comprise, for example, one or more inertial sensors or other devices capable of gathering the information necessary to define a motion state of the electronic device 12.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving from a user terminal first information concerning the user terminal's location;
receiving from the user terminal second information regarding a motion state of the user terminal;
using the first and second information to identify a location-based service applicable to the user terminal; and
transmitting the location-based service to the user terminal.

2. The method of claim 1, wherein the location-based service comprises an advertisement.

3. The method of claim 1, wherein the second information comprises one of a plurality of bit representations, each of the plurality of bit representations representing a particular motion state.

4. The method of claim 1, wherein the second information comprises a heading regarding the direction in which the user terminal is moving.

5. The method of claim 1, wherein the second information differentiates between whether the user terminal is being carried by the user or is inside of a vehicle.

6. A computer program product, embodied in a computer-readable storage medium, comprising computer code configured to perform the processes of claim 1.

7. A method, comprising:
determining first information concerning a location of a user terminal;
determining second information concerning a motion state of the user terminal;
transmitting the first and second information to a location-based service provider; and
in response to the transmission of the first and second information, receiving a location-based service from the location-based service provider, the location-based service having been selected by the location-based service provider based upon the first and second information.

8. The method of claim 7, wherein the location-based service comprises an advertisement.

9. The method of claim 7, wherein the second information comprises one of a plurality of bit representations, each of the plurality of bit representations representing a particular motion state.

10. The method of claim 7, wherein the second information includes a heading regarding the direction in which the user terminal is moving.

11. The method of claim 7, wherein the second information differentiates between whether the user terminal is being carried by the user or is inside of a vehicle.

12. The method of claim 7, wherein at least one sensor is used to determine the second information.

13. The method of claim 7, wherein a global navigation satellite system receiver velocity estimate is used to determine the second information.

14. The method of claim 7, wherein at least one sensor and a global navigation satellite system receiver velocity estimate is used to determine the second information.

15. A computer program product, embodied in a computer-readable storage medium, comprising computer code configured to perform the processes of claim 7.

16. An apparatus, comprising:
a processor; and
a memory communicatively connected to the processor and including:
computer code configured to determine first information concerning a location of a user terminal;
computer code configured to determine second information concerning a motion state of the user terminal;
computer code configured to transmit the first and second information to a location-based service provider; and
computer code configured to, in response to the transmission of the first and second information, process a location-based service received from the location-based service provider, the location-based service having been select by the location-based service provider based upon the first and second information.

17. The apparatus of claim 16, wherein the location-based service comprises an advertisement.

18. The apparatus of claim 16, wherein the second information comprises one of a plurality of bit representations, each of the plurality of bit representations representing a particular motion state.

19. The apparatus of claim 16, wherein the second information includes a heading regarding the direction in which the user terminal is moving.

20. The apparatus of claim 16, wherein the second information differentiates between whether the user terminal is being carried by the user or is inside of a vehicle.

21. The apparatus of claim 16, wherein at least one sensor is used to determine the second information.

22. The apparatus of claim 16, wherein a global navigation satellite system receiver velocity estimate is used to determine the second information.

23. The apparatus of claim 16, wherein at least one sensor and a global navigation satellite system receiver velocity estimate is used to determine the second information.

24. An apparatus, comprising:
means for determining first information concerning a location of a user terminal;
means for determining second information concerning a motion state of the user terminal;
means for transmitting the first and second information to a location-based service provider; and
means for, in response to the transmission of the first and second information, receiving a location-based service from the location-based service provider, the location-based service having been selected by the location-based service provider based upon the first and second information.
